(19) United States
(12) Patent Application Publication
(10) Pub. No.: US 2007/0062110 A1
(43) Pub. Date: Mar. 22, 2007

(54) Water filler for a christmas tree stand

(76) Inventor: Andrew E. Lofboom, Stillwater, MN (US)

Correspondence Address: Galasso & Associates, LP, P.O. Box 26503, Austin, TX, 78755-0503, US

(21) Appl. No.: 11/224,344

(22) Filed: Sep. 12, 2005

(51) Int. Cl. A01G 27/00; A01G 25/00; A47G 33/12

(52) U.S. Cl. 47/48.5; 47/40.5

(57) ABSTRACT

A water filler for a Christmas tree stand which is a simple and inexpensive A water fill funnel is supported by a horizontal holder attached to a vertical support pole that is in turn attached to a horizontal base. A hose extends from the bottom of the funnel far enough for the funnel to be outside the canopy of the Christmas tree. A water spout unit on the end of the hose may be attached to the edge of the water reservoir on a tree stand. Water poured into the funnel runs through the hose and into the reservoir on the tree stand. The user can thus fill and refill the tree stand with water without bending or lying under the branches of the tree and with less chance of spilling water onto the floor or the Christmas presents around the tree.

### FIELD OF THE DISCLOSURE

The present invention relates to an apparatus for filling a Christmas tree stand with water.

### BACKGROUND

To prepare their homes for the Christmas season, many homeowners put up Christmas decorations such as a Christmas tree decorated with colored lights, tinsel, and ornaments and surrounded by presents. Live Christmas trees, usually firs, are used in many households because they have a pleasant scent and can be easily discarded or recycled into mulch after use. Care has to be taken to keep these trees regularly watered to prevent them from becoming so dry that they shed needles and also become a dangerous fire hazard. Consequently, a Christmas tree is typically held in a tree stand with a reservoir for water that must be refilled repeatedly as the tree draws in the water and evaporation further reduces the water level.

However, filling a Christmas tree stand can be awkward and difficult. The low-lying branches under the canopy of a Christmas tree, along with the lights, tinsel, ornaments, and presents, often block access to the tree stand. A user may have to fill a container with water, lie down or kneel on a floor next to the tree to reach the tree stand, move decorations and presents out of the way, and pour water into the tree stand from an awkward position. Unfortunately, it is all too easy for a user's head or shoulders to brush against the branches when filling a tree stand and dislodge needles or ornaments onto the floor. Moreover, it is easy for a user to spill water onto the floor or surrounding presents when filling a tree stand while in an awkward position.

Because of the difficulties that users commonly have with filling tree stands, devices have been devised to help. For example, U.S. Pat. No. 4,930,252 for Krause provides an apparatus with a water level monitor within the reservoir of the tree stand that is electrically connected to a solenoid valve so that water will be supplied from a water reservoir to the tree stand when the water level within the tree stand drops to a predetermined level.

U.S. Pat. No. 5,243,782 for Jones provides a Christmas tree fluid control housing that “includes a first valve and second valve in communication with a first conduit, wherein the first valve selectively directs water flow to a sprinkling ring mounted adjacent an upper distal end of an associated Christmas tree, with a misting ring mounted in surrounding relationship relative to the sprinkling ring operative through a timer mechanism within the fluid control housing.”

U.S. Pat. No. 5,809,691 for Franz provides a decorative upper bell/funnel which can be mounted anywhere in a tree, a connected hose, and a lower bell/funnel connected to the other end of the hose. The upper funnel acts as a decorative object on the tree, while the lower funnel is placed concave down in the stand of the tree.

Although such devices may provide considerable help in filling tree stands and maintaining the water level there, they are complicated and therefore expensive solutions to what is really a very simple problem. Therefore, there is a need for a simple, inexpensive apparatus for filling a Christmas tree stand.

### SUMMARY OF THE DISCLOSURE

The following explanation describes the present invention by way of example and not by way of limitation.

It is an aspect of the present invention to provide a simple, inexpensive apparatus for filling a Christmas tree stand.

It is another aspect of the present invention to provide an apparatus for filling a Christmas tree stand with a hose and nozzle that the user can easily put in place on the tree stand.

It is still another aspect of the present invention to provide an apparatus for filling a Christmas tree stand with simple, effective means to limit spilling.

It is yet another aspect of the present invention to provide an apparatus for easily refilling a Christmas tree stand from outside of the canopy of the tree.

These and other aspects of the present invention will become readily apparent upon further review of the following specification and associated drawings. In accordance with the present invention, a simple, inexpensive apparatus for is provided for filling a Christmas tree stand. A water fill funnel is supported by a horizontal holder attached to a vertical support pole that is in turn attached to a horizontal base. A hose extends from the bottom of the funnel far enough for the funnel to be outside the canopy of the Christmas tree. A water spout unit on the end of the hose may be attached to the edge of the water reservoir on a tree stand. Water poured into the funnel runs through the hose and into the reservoir on the tree stand. The user can thus fill and refill the tree stand with water without bending or lying under the branches of the tree and with less chance of spilling water onto the floor or the Christmas presents around the tree.

### BRIEF DESCRIPTION OF THE DRAWINGS

The following embodiments of the present invention are described by way of example only, with reference to the accompanying drawings, in which:

FIG. 1 is a perspective diagram that illustrates an apparatus for filling a Christmas tree stand; and

FIG. 2 is a perspective diagram that illustrates a water spout unit for an apparatus for filling a Christmas tree stand.

### DETAILED DESCRIPTION OF THE DRAWING FIGURES

The following description of drawings is offered to illustrate the present invention clearly. However, it will be apparent to those skilled in the art that the concepts of the present invention are not limited to these specific details. Also, commonly known elements are shown in diagrams for clarity, as examples only and not as limitations of the present invention.

The present invention comprises a water filler for a Christmas tree stand that may be used in residential and commercial environments, indoors and outdoors. It would be produced from light-weight, durable materials, such as plastic and rubber, in different embodiments.

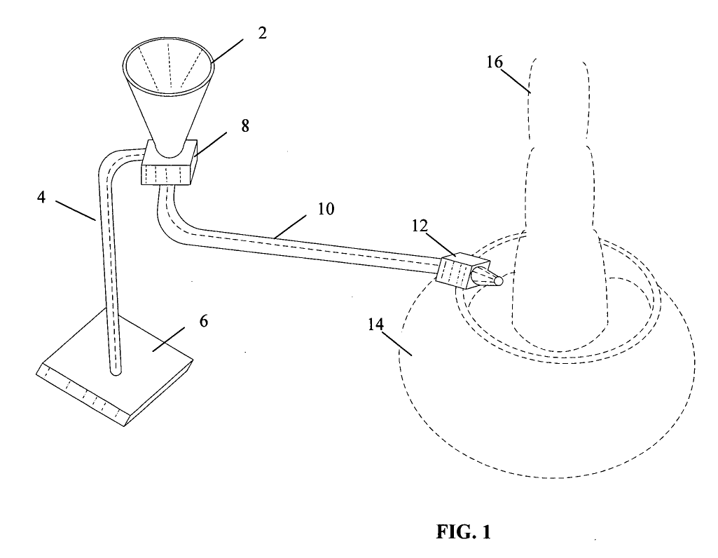

As shown in FIG. 1, the water filler comprises the following elements:
A water fill funnel 2,
A support pole 4,
A base 6,
A horizontal holder 8,
A hose 10, and
A water spout unit 12.

The water fill funnel 2 is supported by a horizontal holder 8 on the end of a vertical support pole 4. The support pole 4 in turn is attached to a horizontal base 8. The water fill funnel 2 serves as a funnel into which the user may pour water for filling a tree stand, limiting spillage of the water. In an embodiment, the water fill funnel 2 is manufactured of plastic.

In embodiment, the horizontal holder 8 may also be manufactured from plastic.

The support pole 4 may comprise a plastic tube with a 90-degree bend. In another embodiment, the support pole 4 may comprise several sections: a vertical pole, a 90-degree plastic elbow fitting, and a short plastic tube.

The base 6 provides horizontal support for the water filler. In an embodiment, the base 6 is also manufactured from a strong, durable plastic and may be square, rectangular, or circular in shape. Christmas tree presents may be placed on the base 6 to weigh it down sufficiently so that it remains in place for filling and refilling the tree with water.

A hose 10 attaches to the bottom of the water fill funnel 2 and ends in a water spout unit 12. In an embodiment, the hose 10 is manufactured of flexible material, for example rubber. In other embodiments, it may be made of rigid material, such as rubber or plastic.

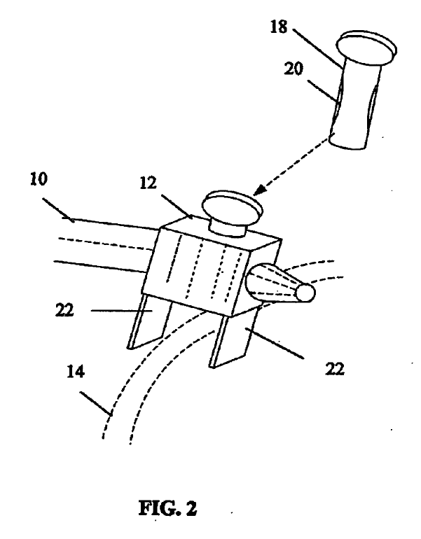

The water spout unit 12 is attached to the edge of a Christmas tree stand 14. Different means of attachment may be used in different embodiments. In one embodiment, the water spout unit 12 may simply be placed on top of the edge of the tree stand 14. In another, it may be attached to the tree stand 14 by means of a clamp, well known to those skilled in the art. FIG. 2 shows an embodiment where the water spout unit 12 attaches to the edge of the tree stand 14 by means of flexible metal or plastic clips 16. A rotatable plug 18 with a hole 20 in its stem may be used to turn on or off the flow of water from the water fill funnel 2, in an embodiment.

Returning to FIG. 1, in an embodiment the water fill funnel 2, base 6, and hose 10 are green in color, and the support pole 4, horizontal holder 8, and water spout unit 12 are red in color.

When fully assembled, the water filler measures twenty-four inches in overall height to the top of the water fill funnel 2 and twenty-four inches in overall length from the water fill funnel 2 to the water spout unit 12, in an embodiment. The water fill funnel 2 may measure five inches in diameter, and the base 6 six inches in diameter.

The best dimensional relationships for the parts of the invention described above, including variations in form and use, will be readily apparent to those skilled in the art, and are intended to be encompassed by the present invention.

In an embodiment, the parts of the water filler are detachable for cleaning, repair, and easy storage.

Use

To use the water filler, the user sets up a Christmas tree stand 14 and places a Christmas tree 16 in the tree stand 14. The user then sets up the components of the water filler so that the water fill funnel 2 is outside the canopy of the Christmas tree 16, which is typically two to three feet from the trunk of the tree. The user then attaches the water spout unit 12 of the water filler to the edge of the tree stand 14. Once the water filler is set up and attached to the tree stand 14, the user does not have to lie down, bend over, or crawl among the presents and branches of the Christmas tree 16 to fill or refill the tree stand 14 with water. The user merely pours water into the water fill funnel 2. The water travels down through the hose 10, out through the water spout unit 12, and into the tree stand 14 to provide water for the tree 16. Because the water filler can be placed outside the canopy of the Christmas tree 16, the user has easy access to the water fill funnel 2. Moreover, the water fill funnel 2 reduces the possibility of spilling the water.

In the embodiment shown in FIG. 2, the user can employ a rotatable plug 18 with a hole 20 in its stem to turn on or off the flow of water from the hose 10 to further reduce spillage.

The user can place Christmas presents around the base 6, shown in FIG. 1, of the water filler, to hold the water filler in place for further use.

1. A water filler for a Christmas tree stand comprising
a funnel,
a support pole comprised of a plastic,
a base,
a horizontal holder wherein said horizontal holder functions to support the funnel and wherein said horizontal holder is supported by said support pole,
a hose,
a water spout unit wherein said water spout unit comprises an adjustable plug with a hole, and
means for attaching the water spout unit to a Christmas tree stand.

2. The support pole of claim 1, wherein the support pole comprises a tube with a 90-degree elbow.

3. The support pole of claim 1, wherein the support pole comprises
a vertical tube,
a 90-degree elbow, and
a horizontal tube.

4. (canceled)

5. (canceled)

6. The means for attaching the water spout unit to a Christmas tree stand of claim 1, wherein the means for attaching the water spout unit to a Christmas tree stand comprises clips.

7. A water filler for a Christmas tree stand comprising
a funnel,
a support pole with a 90-degree elbow,
a base,
a horizontal holder,
a hose,
a water spout unit with an adjustable plug with a hole, and
one or more clips for attaching the water spout unit to a Christmas tree stand.

8. A water filler for a Christmas tree stand comprising
a funnel that is
green in color, and
measures five inches in diameter,
a support pole that
comprises a 90-degree elbow, and
is red in color
a base that
is green in color, and
measures six inches in diameter,
a horizontal holder that is red in color,
a hose that is green in color,
a water spout unit that
comprises an adjustable plug with a hole, and
is red in color, and
one or more clips for attaching the water spout unit to a Christmas tree stand.
